(19) United States
(12) Patent Application Publication
(10) Pub. No.: US 2020/0030071 A1
(43) Pub. Date: Jan. 30, 2020

(54) RESTRAINT SYSTEM FOR ACCESS TO THE CAUDAL END OF ANIMALS USED IN RESEARCH

(71) Applicant: North Carolina State University, Raleigh, NC (US)

(72) Inventors: David Ruppert, Raleigh, NC (US); Denis Marcellin-Little, Davis, CA (US)

(21) Appl. No.: 16/525,399

(22) Filed: Jul. 29, 2019

Related U.S. Application Data
(60) Provisional application No. 62/711,227, filed on Jul. 27, 2018.

(51) Int. Cl. A61D 3/00

(52) U.S. Cl. CPC A61D 3/00; A61D 2003/006; A61D 2003/003

(57) ABSTRACT

An animal restraint device for restraining an animal, such as a rodent, for conducting experiments and collecting data. Restraining devices include a cranial restraint to secure the head and torso of an animal, and a caudal restraint configured to secure the torso of an animal. Restraining devices are made of a flexible material and one or more adjustable fasteners. Animal restraining systems include the animal restraint device and a platform for holding an animal restrained in the restraint device. Methods of using the restraining devices and systems are also provided.

### CROSS-REFERENCE TO RELATED APPLICATIONS

This application claims benefit of U.S. Provisional Patent Application Ser. No. 62/711,227, filed Jul. 27, 2018, herein incorporated by reference in its entirety.

### GRANT STATEMENT

This invention was made with government support under grant number 1441636 awarded by the National Science Foundation. The government has certain rights in the invention.

### TECHNICAL FIELD

Disclosed herein are restraint systems, devices and related methods for restraining animals. More particularly, disclosed here are restraint systems for access to the caudal end of animals used in research.

### BACKGROUND

Several products exist to restrain rodents for research purposes. For example, existing tail restraint systems are useful for gaining access to rat tails for research purposes. However, tail restraint systems require the user to hold the tail to prevent the animal from pulling it back into the container. They also fail to provide any access to any other areas of the rat beyond the tail and the base of the tail.

Another common technique for restraining a rodent is with a conical bag. Conical bags can provide a means to access both the tail and the rump of the animal. However, restraint bags do not allow the user to release the bag without permitting the animal to freely exit the restraint.

Additional restraints are available which provide more open access with limited contact with the animal. However, such devices do not allow for hands-free access to the hind limbs of the rodent while awake, and such devices allow the rodent to freely move its limbs, disrupting treatments or measurements.

Other existing restraint devices that are placed around rodents allow the rodent can struggle free from the restraint when not held by a technician.

Finally, a system which holds a rat down through several lateral straps fails to prevent the rodent from withdrawing its limbs under its body preventing access for treatments or measurements.

No existing restraint system has demonstrated that it can restrain a rodent sufficiently to allow access to the hind limbs for hands-free administration of treatments or data collection while awake. Thus, what is needed is a restraint system which adequately restrains rodents while allowing sufficient access to the caudal end for administering hands-free treatments; for taking measurements; and/or experimentations and manipulations without sustained inhalation anesthesia.

### SUMMARY

This summary lists several embodiments of the presently disclosed subject matter, and in many cases lists variations and permutations of these embodiments. This summary is merely exemplary of the numerous and varied embodiments. Mention of one or more representative features of a given embodiment is likewise exemplary. Such an embodiment can typically exist with or without the feature(s) mentioned; likewise, those features can be applied to other embodiments of the presently disclosed subject matter, whether listed in this summary or not. To avoid excessive repetition, this Summary does not list or suggest all possible combinations of such features.

In some embodiments, provided herein are animal restraint devices, the restraint devices comprising a cranial restraint configured to secure a head and torso of an animal, and a caudal restraint configured to secure the torso of an animal, wherein the cranial restraint and caudal restraint comprise a flexible material and one or more adjustable fasteners, wherein the cranial restraint and caudal restraint are configured to be mechanically connected to one another. In some embodiments, such devices further comprise a plurality of straps and adjustable fasteners configured to wrap around an upper pelvic limb of the animal. In some embodiments, such devices further comprise one or more of a ventral strap, lateral strap, abductor strap, and leg strap.

In some embodiments, the caudal restrain comprises a base, wherein the plurality of straps extend substantially perpendicular from the base. In some embodiments, the caudal restrain further comprises a tail hole located substantially centrally on the base. In some embodiments, the caudal restraint comprises a length of about 50 mm to about 300 mm, and a width of about 50 mm to about 350 mm, wherein the cranial restraint comprises a width of about 200 mm to about 300 mm, and a length of about 140 mm to about 180 mm.

In some embodiments, a cranial restraint is configured to simultaneously prevent the animal from advancing forward out of the restraint device and substantially reducing visual stimuli in the animal. In some embodiments, the cranial restraint is configured to secure the head and torso of the animal while allowing an aperture for breathing.

In some embodiments, the device is configured to secure a hind limb of the animal while allowing access to a tail and/or hind limb of the animal. In some embodiments, the flexible material comprises a flexible and/or breathable fabric. In some embodiments, the flexible material comprises an adhesive and latex free flexible composite of open-cell foam and soft fabric. In some embodiments, the one or more adjustable fasteners comprise hook and loop fasteners. In some embodiments, the device is configured to secure a rodent, wherein the rodent is selected from a rat or mouse.

Provided herein are animal restraint systems, comprising an animal restraint device, and a platform for holding an animal restrained in the restraint device. In some embodiments, such systems can further comprise one or more accessory straps. In some embodiments, such systems can further comprise a stand for supporting the platform.

Provided herein are methods of restraining an animal, comprising providing an animal to be restrained, providing an animal restraint device, applying a caudal restraint to the animal, applying a cranial restraint to the animal, and securing the cranial restraint to the caudal restraint, whereby the animal is restrained from freely moving. In some embodiments, applying the caudal restraint further comprises positioning a tail of the animal through a tail hole in the caudal restraint, positioning a ventral strap of the caudal restraint cranially across an abdomen of the animal to the base of a sternum of the animal, securing a lateral strap of the caudal restraint around a midsection of the animal, securing an abductor strap around a pelvic joint of the animal to a dorsal side of the caudal restraint, and securing a hind limb of the animal in a flexed orientation by positioning a leg strap across a body of the animal to an opposite side ventrally. In some embodiments, the methods further comprise securing the restrained animal to a platform. In some embodiments, such methods further comprise collecting a sample from or taking measurements from the restrained animal.

Accordingly, it is an object of the presently disclosed subject matter to provide restraint systems, devices and related methods for restraining animals. This and other objects are achieved in whole or in part by the presently disclosed subject matter. Further, an object of the presently disclosed subject matter having been stated above, other objects and advantages of the presently disclosed subject matter will become apparent to those skilled in the art after a study of the following description, Drawings and Examples.

### BRIEF DESCRIPTION OF THE DRAWINGS

The presently disclosed subject matter can be better understood by referring to the following figures. The components in the figures are not necessarily to scale, emphasis instead being placed upon illustrating the principles of the presently disclosed subject matter (often schematically). In the figures, like reference numerals designate corresponding parts throughout the different views. A further understanding of the presently disclosed subject matter can be obtained by reference to an embodiment set forth in the illustrations of the accompanying drawings. Although the illustrated embodiment is merely exemplary of systems for carrying out the presently disclosed subject matter, both the organization and method of operation of the presently disclosed subject matter, in general, together with further objectives and advantages thereof, may be more easily understood by reference to the drawings and the following description. The drawings are not intended to limit the scope of this presently disclosed subject matter, which is set forth with particularity in the claims as appended or as subsequently amended, but merely to clarify and exemplify the presently disclosed subject matter.

For a more complete understanding of the presently disclosed subject matter, reference is now made to the following drawings in which:

FIGS. 1A and 1B are top and bottom plan views, respectively, of a caudal restraint component of a restraint system disclosed herein;

FIGS. 2A and 2B are top and bottom plan views, respectively, of a cranial restraint component of a restraint system disclosed herein;

FIG. 3 shows plan views of accessory straps for use in restraint systems disclosed herein; and

FIGS. 4-10 are photographic images of the disclosed restraint systems in use to restrain a rat.

### DETAILED DESCRIPTION

The presently disclosed subject matter now will be described more fully hereinafter, in which some, but not all embodiments of the presently disclosed subject matter are described. Indeed, the presently disclosed subject matter can be embodied in many different forms and should not be construed as limited to the embodiments set forth herein; rather, these embodiments are provided so that this disclosure will satisfy applicable legal requirements.

### I. Definitions

The terminology used herein is for the purpose of describing particular embodiments only and is not intended to be limiting of the presently disclosed subject matter. While the following terms are believed to be well understood by one of ordinary skill in the art, the following definitions are set forth to facilitate explanation of the presently disclosed subject matter.

All technical and scientific terms used herein, unless otherwise defined below, are intended to have the same meaning as commonly understood by one of ordinary skill in the art. References to techniques employed herein are intended to refer to the techniques as commonly understood in the art, including variations on those techniques or substitutions of equivalent techniques that would be apparent to one of skill in the art. While the following terms are believed to be well understood by one of ordinary skill in the art, the following definitions are set forth to facilitate explanation of the presently disclosed subject matter.

In describing the presently disclosed subject matter, it will be understood that a number of techniques and steps are disclosed. Each of these has individual benefit and each can also be used in conjunction with one or more, or in some cases all, of the other disclosed techniques.

Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

Following long-standing patent law convention, the terms “a”, “an”, and “the” refer to “one or more” when used in this application, including the claims. Thus, for example, reference to “a cell” includes a plurality of such cells, and so forth.

Unless otherwise indicated, all numbers expressing quantities of ingredients, reaction conditions, and so forth used in the specification and claims are to be understood as being modified in all instances by the term “about”. Accordingly, unless indicated to the contrary, the numerical parameters set forth in this specification and attached claims are approximations that can vary depending upon the desired properties sought to be obtained by the presently disclosed subject matter.

As used herein, the term “about,” when referring to a value or to an amount of a composition, dose, sequence identity (e.g., when comparing two or more nucleotide or amino acid sequences), mass, weight, temperature, time, volume, concentration, percentage, etc., is meant to encompass variations of in some embodiments ±20%, in some embodiments ±10%, in some embodiments ±5%, in some embodiments ±1%, in some embodiments ±0.5%, and in some embodiments ±0.1% from the specified amount, as such variations are appropriate to perform the disclosed methods or employ the disclosed compositions.

The term “comprising”, which is synonymous with “including” “containing” or “characterized by” is inclusive or open-ended and does not exclude additional, unrecited elements or method steps. “Comprising” is a term of art used in claim language which means that the named elements are essential, but other elements can be added and still form a construct within the scope of the claim.

As used herein, the phrase “consisting of” excludes any element, step, or ingredient not specified in the claim. When the phrase “consists of” appears in a clause of the body of a claim, rather than immediately following the preamble, it limits only the element set forth in that clause; other elements are not excluded from the claim as a whole.

As used herein, the phrase “consisting essentially of” limits the scope of a claim to the specified materials or steps, plus those that do not materially affect the basic and novel characteristic(s) of the claimed subject matter.

With respect to the terms “comprising”, “consisting of”, and “consisting essentially of”, where one of these three terms is used herein, the presently disclosed and claimed subject matter can include the use of either of the other two terms.

As used herein, the term “and/or” when used in the context of a listing of entities, refers to the entities being present singly or in combination. Thus, for example, the phrase “A, B, C, and/or D” includes A, B, C, and D individually, but also includes any and all combinations and subcombinations of A, B, C, and D.

The disclosed devices, systems and any related methods are configured for use with rodents, including for example but not limited to, rats and mice. Although it is to be understood that the principles of the disclosed subject matter indicate that the disclosed devices, systems and any related methods can be effective for and/or configured to be use with other vertebrate species, including mammals, which are intended to be included in the term “subject”. Moreover, a mammal is understood to include any mammalian species to be secured by the disclosed devices and systems, particularly research, agricultural and domestic mammalian species. In some embodiments, the disclosed devices, systems and any related methods are particularly useful in the securing and/or restraining warm-blooded vertebrates. Thus, the presently disclosed subject matter concerns mammals and birds. In some embodiments, the subject to be used in accordance with the presently disclosed subject matter is a subject in need of treatment and/or diagnosis, and/or from which experimental data is to be collected.

### II. Animal Restraint Devices, Systems and Methods

In some embodiments, the presently disclosed subject matter provides an animal restraint system. In some aspects, the presently disclosed subject matter addresses the need to safely and effectively apply a treatment to the back legs of animals, particularly research animals, such for example rats and mice, as part of research and experimental trials. In some aspects such trials can include investigating the influence of vibration or ultrasound on bone ingrowth into metal implants.

In some embodiments, disclosed herein are animal restraint devices and/or systems, comprising a cranial restraint configured to secure a head and torso of an animal, and a caudal restraint configured to secure the torso of an animal. The cranial restraint and caudal restraint can comprise a flexible material and one or more adjustable fasteners. The cranial restraint and caudal restraint can be configured to be mechanically connected to one another. In some aspects, such restraint devices and/or systems can further comprise a plurality of straps and adjustable fasteners configured to wrap around an upper pelvic limb of the animal.

In some aspects, such restraint devices and/or systems can further comprise a cranial hood configured to simultaneously prevent the animal from advancing forward out of the restraint device and substantially reducing visual stimuli in the animal. In some aspects, the cranial hood is a component of the cranial restraint. The cranial restraint can be configured to secure the head and torso of the animal while allowing an aperture for breathing.

The device and/or system can be configured to secure a hind limb of the animal while allowing access to a tail and/or hind limb of the animal. In some aspects, such restraint devices and/or systems can further comprise one or more accessory straps.

The flexible material of the restraint devices and/or systems can comprise a flexible and/or breathable fabric. By way of example and not limitation, such flexible material can comprise an adhesive and latex free flexible composite of open-cell foam and soft fabric. The one or more adjustable fasteners can comprise hook and loop fasteners.

In some aspects, such restraint devices and/or systems can be configured to secure a rodent, such as a rat, mouse or other rodent, wherein the device can be adjustable in size to accommodate varying sizes of rodents.

In some aspects, such restraint devices and/or systems can further comprise a platform for holding and/or positioning an animal restrained in the restraint device.

In some embodiments, and as discussed further herein and shown in the figures, methods of restraining animals are provided. For example, a method of restraining an animal can comprise providing an animal to be restrained, providing the animal restraint device as disclosed herein, applying the caudal restraint to the animal, applying the cranial restraint to the animal, and securing the cranial restraint to the caudal restraint, whereby the animal is restrained from freely moving. In some aspects, applying the caudal restraint can further comprise positioning a tail of the animal through a tail hole in the caudal restraint, positioning a ventral strap of the caudal restraint cranially across an abdomen of the animal to the base of a sternum of the animal, securing a lateral strap of the caudal restraint around a midsection of the animal, securing an abductor strap around a pelvic joint of the animal to a dorsal side of the caudal restraint, and securing a hind limb of the animal in a flexed orientation by positioning a leg strap across a body of the animal to an opposite side ventrally. Similar methods, with variations of the order of the above steps, can also be employed to restrain an animal. Once restrained, methods can further comprise securing the restrained animal to a platform. Finally, once restrained, a sample or measurement can be taken from the restrained animal.

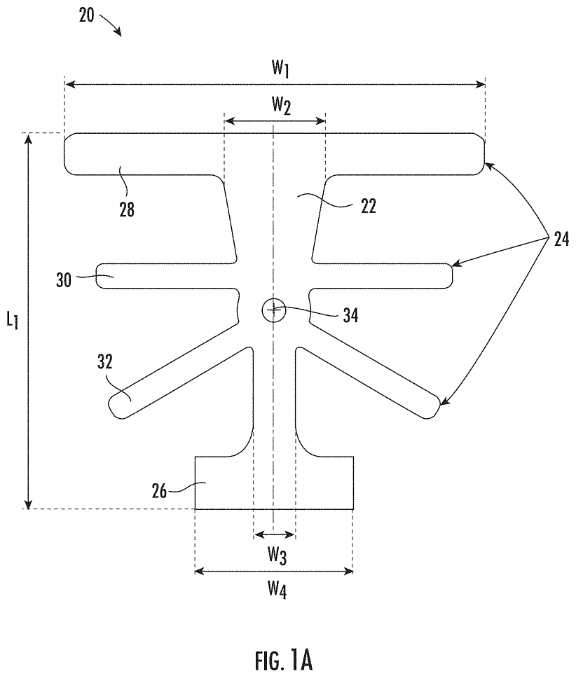

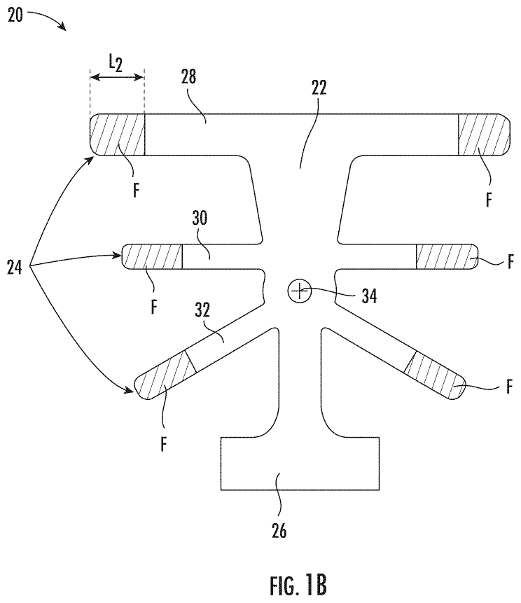

Turning now to the figures, FIGS. 1A and 1B are top and bottom plan views, respectively, of a caudal restraint 20 of the disclosed restraint devices, also referred to as a caudal restraint component of a restraint system as disclosed herein. Caudal restraint 20 comprises a base 22 or central region with a plurality of straps, generally referred to as straps 24, extending perpendicular or substantially perpendicular therefrom, all centered or substantially centered around tail hole 34.

Base 22 of caudal restraint 20 can be of varying widths and lengths, including for example a length L1 of about 50 mm to about 300 mm, or about 100 mm to about 250 mm, or about 150 mm to about 200 mm. In some embodiments, caudal restraint 20 can have an overall width W1 of varying dimensions, including about 50 mm to about 350 mm, or about 100 mm to about 300 mm, or about 150 mm to about 250 mm. Base 22 of caudal restraint 20 can be of varying widths, including for example a width W2, of a portion extending dorsally from tail hole 34, of about 30 mm to about 70 mm, or about 40 mm to about 60 mm. Width W2 of the portion of base 22 extending dorsally from tail hole 34 can vary in width, or be tapered, in some embodiments. In some aspects, a portion of base 22 extending ventrally from tail hole 34 can have a width W3 of about 10 mm to about 30 mm, or about 15 mm to about 25 mm.

Caudal restraint 20 can comprise a plurality of straps 24 extending perpendicular or substantially perpendicular from base 22, including for example but not limited to, ventral straps 26, lateral straps 28, abductor straps 30, and leg straps 32. In some embodiments, and as shown in FIGS. 1A and 1B, straps 24, and particularly ventral straps 26, lateral straps 28, abductor straps 30, and leg straps 32, are configured as matching pairs, or mirror images, on each side of a central vertical axis of base 22. The length of each strap 24 can vary, but are generally substantially equal to or less than width W1 noted herein. The combined width of ventral straps 26, forming a terminal end of base 22 extending ventrally from central tail hole 34, can in some aspects have a width W4 of about 55 mm to about 95 mm, or about 65 mm to about 85 mm.

In some aspects, and by way of example and not limitation, caudal restraint 20 can have a length L1 of about 180 mm, width W1 of about 200 mm, width W2 of about 50 mm, width W3 of about 20 mm, and a width W4 of about 75 mm.

As shown in FIG. 1B, one side, e.g. a bottom side, of caudal restraint 20 can include one or more fasteners F attached to or otherwise incorporated with straps 24. Some or all of straps 24 can include one or more fasteners F. In some aspects, fasteners F can comprise any suitable fastening device or component, including but not limited to hook-and-loop fasteners (e.g., VELCRO®, Manchester, N.H., United States of America) or similar, buttons, snaps, magnets, and the like. As shown in FIG. 1B, fasteners can be positioned near a terminal end of each strap 24, and can have any suitable size or length, including for example a length L2 of about 10 mm to about 30 mm, or about 15 mm to about 25 mm. In some aspects, fasteners F can be configured to attached to or otherwise secure straps 24 to base 22 and/or other straps 24.

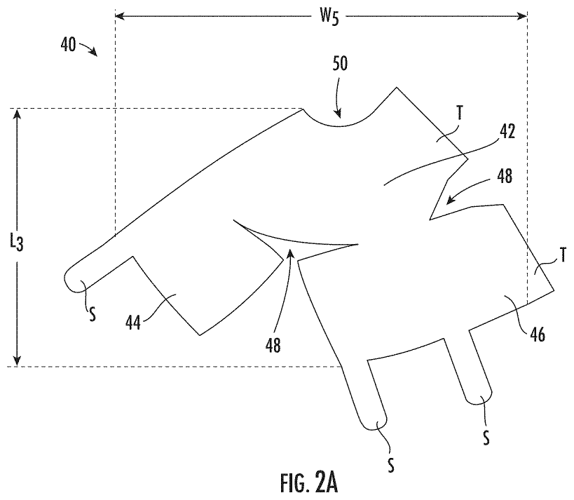

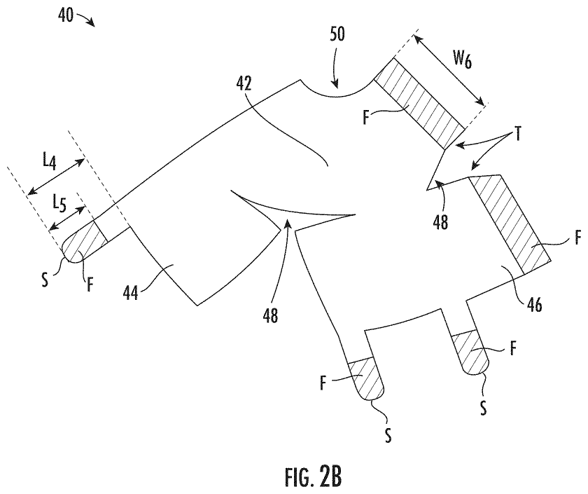

FIGS. 2A and 2B are top and bottom plan views, respectively, of a cranial restraint 40, or cranial restraint component, of a restraint device and/or system disclosed herein. Cranial restraint 40, shown in FIGS. 2A and 2B in an open or flattened orientation, can comprise a hood 42 and two or more panels 44, 46, configured to fold over one another to form a conical shaped restraint for securing the head and upper torso of a rodent or animal. Cranial restraint 40 can comprise a plurality of tabs T and straps S to secure hood 42 and panels 44, 46 to one another in a closed or folded position when in use. One or more apertures 48 or slits can be provided in or between hood 42 and panels 44, 46 to allow each of the components to be folded into a conical or cone shape when applied to an animal. A breathing aperture 50 can be provided at one end of hood 42 to allow for the animal's nose to protrude from hood 42 to allow adequate air flow and breathing.

In some embodiments, when laid out in an open and/or flatted orientation cranial restraint 40 forms a substantially triangular shape having an overall width W5 of about 200 mm to about 300 mm, or about 225 mm to about 275 mm, with an overall length L3 of about 140 mm to about 180 mm, or about 150 mm to about 170 mm. As shown in FIG. 2B, tabs T and straps S can be of any suitable length and/or width, including for example length L4 of about 35 mm to about 55 mm, or about 40 mm to about 50 mm, and a width W6 of about 50 mm to about 70 mm, or about 55 mm to about 65 mm.

In some aspects, and by way of example and not limitation, cranial restraint 40 can have a length L3 of about 159 mm, width W5 of about 253 mm, width W6 of about 62 mm, and length L4 of about 45 mm.

As shown in FIG. 2B, one side, e.g. a bottom side, of cranial restraint 40 can include one or more fasteners F attached to or otherwise incorporated with straps S and/or tabs T. Some or all of straps S and/or tabs T can include one or more fasteners F. In some aspects, fasteners F can comprise any suitable fastening device or component, including but not limited to hook-and-loop fasteners (e.g., VELCRO®) or similar element, buttons, snaps, magnets, and the like. As shown in FIG. 2B, fasteners F can be positioned near a terminal end of each straps S and/or tabs T, and can have any suitable size or length, including for example a length L5 of about 20 mm to about 40 mm, or about 25 mm to about 35 mm, or a width W6 of about 50 mm to about 70 mm, or about 55 mm to about 65 mm. In some aspects, fasteners F can be configured to attached to or otherwise secure straps S and/or tabs T to cone 42 and/or to other straps S and/or tabs T.

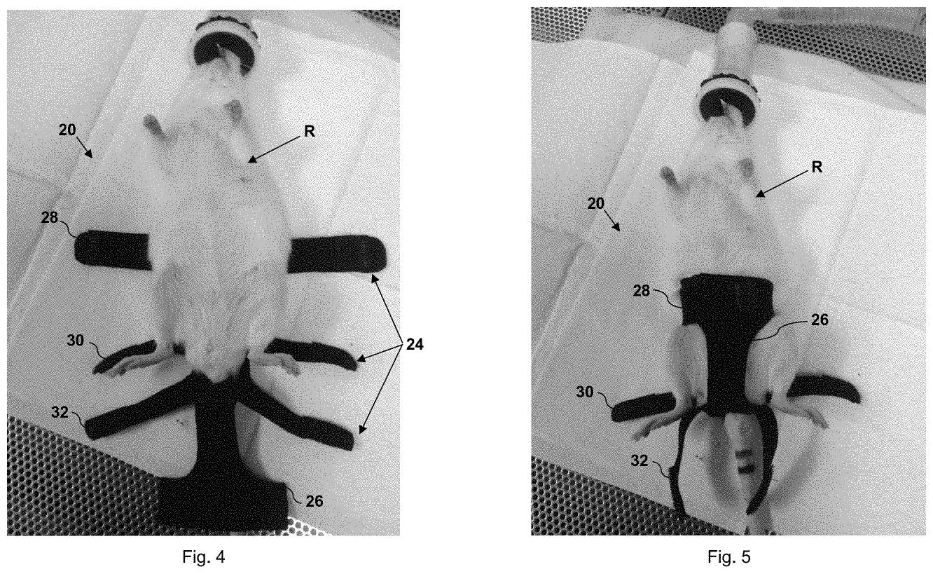

In some embodiments, the disclosed restraint system and/or device is configured such that caudal restraint 20 attaches to cranial restraint 40, using one or more fasteners F, when in use to form a restraint system for restraining an animal or rodent for research purposes. FIGS. 4-10, discussed hereinbelow, illustrate such use using photographic images of the disclosed restraint devices and systems in use to restrain a rat.

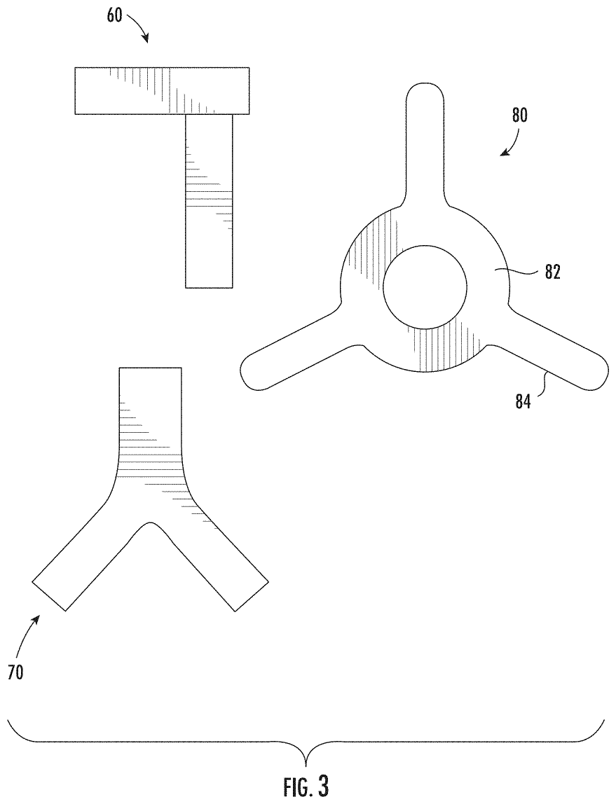

FIG. 3 shows plan views of various accessory straps for use in restraint systems and devices disclosed herein. Accessory straps 60, 70 and 80 can be configured in various shapes, designs and sizes as shown in FIG. 3. Accessory strap 60 can comprises a substantially L-shaped or T-shaped piece of fabric or material. Accessory strap 70 can comprises a substantially Y-shaped piece of fabric or material. Accessory strap 80 can comprises a substantially O-shaped piece of fabric or material, comprising a central O-shaped portion 82 with one or more strips 84 extending radially therefrom.

In some aspects all, substantially all, or select parts of accessory straps 60, 70 and 80 can comprise one or more fastening components, including for example a hook-and-loop material as used in caudal restraint 20 and cranial restraint 40. Accessory straps 60, 70 and 80 can be configured to be used in conjunction with caudal restraint 20 and cranial restraint 40 to secure an animal or rodent, as further illustrated in FIGS. 4-10. Accessory straps 60, 70 and 80, with one or more fastening components, can be configured to attach to caudal restraint 20 and cranial restraint 40, e.g. by hook-and-loop fasteners.

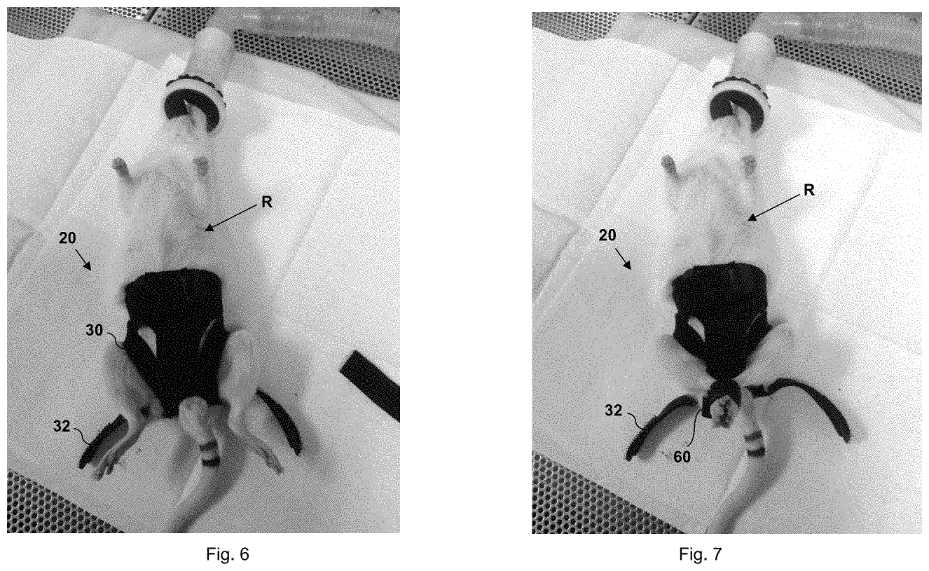

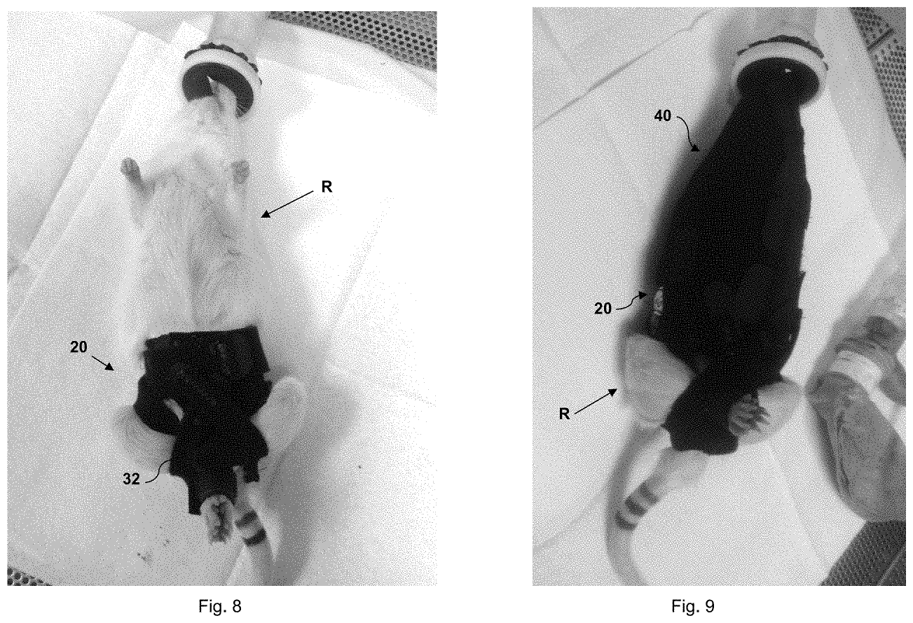

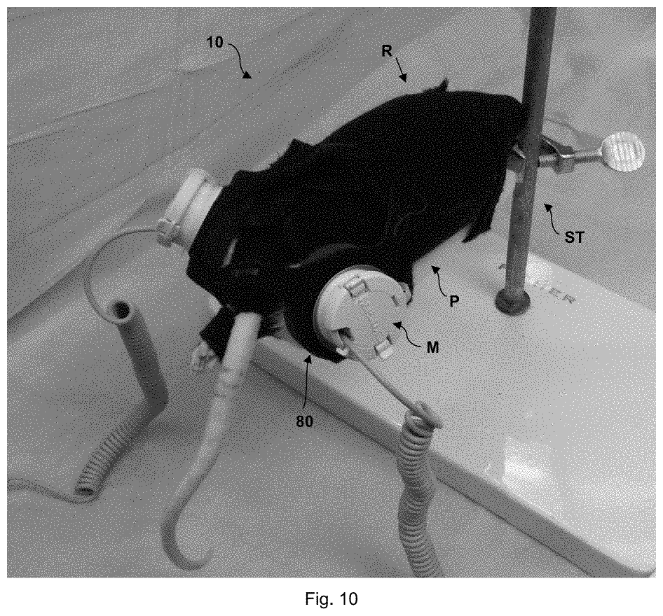

FIGS. 4-10 are photographic images of the disclosed restraint devices and systems in use to restrain a rat. As shown in FIGS. 4-10, the disclosed restraining system 10 (see FIG. 10) securely holds a rat or rodent R on a platform P with both of its pelvic limbs immobilized and located relative to the restraint for repeatable application of treatment or measurement of biological response. The restraint of the animal can be achieved with any rodent, including one that is either tame or while briefly subdued through inhalation anesthesia. To restrain a rodent R, first the animal's tail is brought through tail hole 34 of caudal restraint 20, with ventral strap 26 oriented such that it extends behind the animal with the soft surface, or top side shown in FIG. 1A, of the restraint facing away from rodent R (FIG. 4). Next, the ventral strap 26 is brought cranially across the abdomen to the base of the sternum of rodent R and the lateral straps 28 secured snugly around the midsection of rodent R (FIG. 5). The abductor straps 30 are then led around the pelvic joint of rodent R and secured to the dorsal side of the restraint (FIG. 6). Then the two hind feet are bound together with an accessory strap, such as for example accessory strap 60 or 70 of FIG. 3. As shown in FIG. 7, accessory strap 60, or foot strap, and particularly the perpendicular piece of the L-shaped strap can be secured to the ventral strap 26 after securing the feet of the rodent R (FIG. 7). The positioning of caudal restraint 20 can be completed with securing the hind limbs or legs in a flexed orientation by bringing leg straps 32 across the body to opposite sides ventrally (FIG. 8). The hind limbs can be further constrained to either side, cranially or caudally with an additional strap, such as for example accessory strap 70, also referred to as a caudal foot strap (FIG. 3).

After adjusting to the appropriate size, the cranial restraint 40 is applied to rodent R by sliding the hood over the head and torso of the rodent R and securing it to the caudal restraint 20 (FIG. 9). With the animal fully restrained, in some embodiments, and depending on the testing to be done, rodent R can be secured to a platform P or similar cradling device for hands-free collection of measurements or application of experimental treatments (FIG. 10). In some aspects, platform P can be supported by a stand ST or like securing mechanism. Measurement devices M or other sensory devices can be secured to the restraint device 10 via one or more accessory straps, including for example strap 80. Using the disclosed restraint devices and systems animals typically exhibit minimal resistance to being restrained, particularly with the hood blacking out their vision of the surrounding laboratory.

As will be appreciated by one of ordinary skill in the art, the above described sequence of steps can be changed or varied as needed in order to properly and effectively apply the restraining devices and systems to an animal. For example, the cranial restraint could be applied before the caudal restraint, etc.

In some embodiments, the disclosed restraint system can be configured to secure the caudal restraint of the restraint to a cranial restraint which secures the head and torso of the animal while allowing an aperture for breathing without the need for a technician to physically tend the animal. The caudal restraint can be configured to use straps to snugly wrap around the upper pelvic limb preventing the animal from pulling its legs up into the restraint. Once in the restraint, the animal to be restrained can be placed on a platform from which its legs can dangle thereby providing no surface from which the animal can push off. Moreover, in some aspects, the cranial restraint does not provide sufficient room for the animal to turn around nor advance forward. The two components, the caudal restraint and cranial restraint, can be secured or otherwise mechanically linked together thereby preventing the animal from backing out. The restraint system can be configured to allow access to the hind limbs and tail, allowing for hands-free treatment application or collection from either the tail or hind limbs of the animal.

In some aspects, the disclosed restraint systems and devices can be configured to secure a rodent, including but not limited to a rat or mouse, ranging in size from about 20 grams to about 500 grams, in some embodiments about 50 grams to about 450 grams, in some embodiments about 100 grams to about 400 grams, or in some embodiments about 150 grams to about 350 grams. In some aspects, the disclosed restraint systems and devices can be configured to secure the hind limbs of a medium size rat (e.g. about 300 grams to about 350 grams, including for example about 320±80 gm) in a flexed and externally rotated orientation for application of multiple therapeutic treatments to the thigh region. While in some embodiments the geometry and configuration of the disclosed restraint system can be optimized for restraint of a medium size rat (see, e.g., FIGS. 4-10), one of ordinary skill in the art will appreciate that such dimensions can be optimized to facilitate the restraint of any size rodent or other animal.

In some embodiments, the disclosed restraint systems and devices can be constructed from a breathable and/or flexible fabric or other suitable material to facilitate extended restraint of the animal and maximize the restrained animal's comfort. In some aspects it can be advantageous for the outer surface of the fabric to have a soft tight-looped texture for securing adjustable hook-and-loop fasteners. By way of example and not limitation, an appropriate fabric which incorporates the desired features includes a substantially adhesive- and latex-free flexible composite of open-cell foam and soft fabric (e.g., BREATH-O-PRENE®, TANKindustries, Buffalo, N.Y., United States of America) or similar material. Correspondingly, in some embodiments, the ends of the straps used for securing various regions of the restraint systems and devices can be fitted with adjustable fasteners such as hook-and-loop fasteners (e.g., VELCRO®, Manchester, N.H., United States of America) or similar components. As discussed herein, various accessory straps (FIG. 3) can be used to place the limbs in specific positions, as needed and/or position devices for measurement of or application to the hind region of the restrained animal.

The cranial hood restraint is adjustable, at least in part due to the use of flexible material and adjustable fasteners, e.g. hook-and-loop fasteners, to accommodate a wide range of animal girth. The cranial hood is designed to, at least in part, eliminate visual stimuli in the laboratory thereby reducing the stress of the animal. In some embodiments, the hood or cranial restraint can also be constructed from transparent material, or include a portion made from transparent material, in order to visually monitor the subject if visual stimuli were deemed to be of no concern.

In some embodiments, the components of the restraint devices and systems can be reusable and washable. Experimental results confirmed that the hook and loop fasteners securely contained rodents for over 320 minute long applications per restraint.

While one application of the disclosed restraint devices and systems is to restrain a rat, mouse or rodent with its hind limbs in a flexed and externally rotated position, the ultimate use of the presently disclosed subject matter is not limited to such applications. Additional or alternative straps, fasteners and/or accessory straps can be constructed to secure and restrain an animal with their hind limbs, or other limbs, in a variety of orientations.

The disclosed restraint systems can, in some embodiments, be useful for rodents that are flexible and adept and eluding restraint and fitting through small spaces. However, this design can also be applied in the restraint of other animals. While some dimensions and geometry are most suitable for the restraint of a rat, the system is scalable, including within the dimensions provided herein, to facilitate the restraint of various quadrupeds. For example, the restraint devices and systems can be scaled down to restrain a mouse or similarly sized animal. The restraint devices and systems can also be enlarged to accommodate a guinea pig, rabbit or larger animal such as a beaver.

The disclosed restraint devices and systems can be applicable to orthopedic animal studies investigating the osteogenic response to locally applied treatments to the hind limbs. The disclosed restraint devices and systems can be used to explore local therapeutic treatments in rodent models for a variety of diseases, such as for example no-union in fracture healing, pain relief of arthrofibrosis and relief from rheumatoid arthritis. The disclosed restraint devices and systems can also be utilized for various investigations requiring either the measurements of biological responses or the local application of treatments to the hind region to an animal without sustained inhalation anesthesia. These uses could include, but are not limited to, locally applied mechanical or electrical stimulation to limb joints, bones or muscles; sustained intravenous tail injections or withdrawals; or measurement of muscle activities over time. The disclosed restraint devices and systems are useful for animal researchers performing exploratory studies but can extend to veterinary, zoology or other similar industries for containment or transport of an animal, study of a restrained animal, etc.

Restraint systems currently available do not restrain rodents sufficiently to allow access to the hind limbs for hands-free administration of treatments or data collection while awake. No restraint system currently exists which adequately restrains rodents while allowing sufficient access to the caudal end for administering hands-free treatments, for taking measurements, or experimentations and manipulations without sustained inhalation anesthesia. The disclosed restraint devices and systems overcome these deficiencies by providing effective means for immobilizing the hind limbs, preventing the animal from turning around in the restraint, advancing forward out of the restraint and from being startled or disturbed by visual stimuli. This disclosed restraint devices and systems provide for effective administration of hands-free treatments; taking measurements; or experimentations and manipulations on an animal without sustained inhalation anesthesia.

### III. Example

An initial restraint system was created around a 3D printed rat and fabricated from a computerized-tomography scan. This initial design failed to maintain the location of the applicator/measurement points relative to the thigh and allowed the animal to freely exit the restraint. Next, a cranial hood was designed to simultaneously prevent the animal from advancing forward out of the restraint and to eliminate visual stimuli in the laboratory, thereby reducing the stress of the animal.

A second design of the caudal restraint was constructed. As in the first design, the second design maintained the same shortcoming of failing to maintain the location of the applicator/measurement points relative to the thigh. Subsequently, the design of the caudal restraint was changed from a “sleeve” construction to a “strap” construction and iterated upon several times to configure the position and orientation of the straps. The applicator/measurement points were removed from the caudal restraint to facilitate user-specific positioning and allow a variety of applicator and measurement devices.

The resultant restraint system and device as disclosed herein, and as shown in FIGS. 1-10, can be adjusted and modified to facilitate the application of various treatments to different aspects of the pelvic limb of a rodent.

It will be understood that various details of the presently disclosed subject matter may be changed without departing from the scope of the presently disclosed subject matter. Furthermore, the foregoing description is for the purpose of illustration only, and not for the purpose of limitation.

What is claimed is:

1. An animal restraint device, the restraint device comprising:
a cranial restraint configured to secure a head and torso of an animal; and
a caudal restraint configured to secure the torso of an animal,
wherein the cranial restraint and caudal restraint comprise a flexible material and one or more adjustable fasteners,
wherein the cranial restraint and caudal restraint are configured to be mechanically connected to one another.

2. The animal restraint device of claim 1, further comprising a plurality of straps and adjustable fasteners configured to wrap around an upper pelvic limb of the animal.

3. The animal restraint device of claim 2, further comprising one or more of a ventral strap, lateral strap, abductor strap, and leg strap.

4. The animal restraint device of claim 2, wherein the caudal restrain comprises a base, wherein the plurality of straps extend substantially perpendicular from the base.

5. The animal restraint device of claim 4, further comprising a tail hole located substantially centrally on the base.

6. The animal restraint device of claim 1, wherein the caudal restraint comprises a length of about 50 mm to about 300 mm, and a width of about 50 mm to about 350 mm, wherein the cranial restraint comprises a width of about 200 mm to about 300 mm, and a length of about 140 mm to about 180 mm.

7. The animal restraint device of claim 1, further comprising a cranial restraint configured to simultaneously prevent the animal from advancing forward out of the restraint device and substantially reducing visual stimuli in the animal.

8. The animal restraint device of claim 1, wherein the cranial restraint is configured to secure the head and torso of the animal while allowing an aperture for breathing.

9. The animal restraint device of claim 1, wherein the device is configured to secure a hind limb of the animal while allowing access to a tail and/or hind limb of the animal.

10. The animal restraint device of claim 1, wherein the flexible material comprises a flexible and/or breathable fabric.

11. The animal restraint device of claim 10, wherein the flexible material comprises an adhesive and latex free flexible composite of open-cell foam and soft fabric.

12. The animal restraint device of claim 1, wherein the one or more adjustable fasteners comprise hook and loop fasteners.

13. The animal restraint device of claim 1, wherein the device is configured to secure a rodent, wherein the rodent is selected from a rat or mouse.

14. An animal restraint system, comprising the animal restraint device of claim 1, and a platform for holding an animal restrained in the restraint device.

15. The animal restraint system of claim 14, further comprising one or more accessory straps.

16. The animal restraint system of claim 14, further comprising a stand for supporting the platform.

17. A method of restraining an animal, the method comprising:
providing an animal to be restrained;
providing the animal restraint device of claim 1;
applying the caudal restraint to the animal;
applying the cranial restraint to the animal; and
securing the cranial restraint to the caudal restraint,
whereby the animal is restrained from freely moving.

18. The method of claim 17, wherein applying the caudal restraint further comprises:
positioning a tail of the animal through a tail hole in the caudal restraint;
positioning a ventral strap of the caudal restraint cranially across an abdomen of the animal to the base of a sternum of the animal;
securing a lateral strap of the caudal restraint around a midsection of the animal;
securing an abductor strap around a pelvic joint of the animal to a dorsal side of the caudal restraint; and
securing a hind limb of the animal in a flexed orientation by positioning a leg strap across a body of the animal to an opposite side ventrally.

19. The method of claim 17, further comprising securing the restrained animal to a platform.

20. The method of claim 17, further comprising collecting a sample from or taking measurements from the restrained animal.
